(19) United States
(12) Patent Application Publication
(10) Pub. No.: US 2004/0135927 A1
(43) Pub. Date: Jul. 15, 2004

(54) Method and device for improving the grey scale resolution of a pulse width modulated image display device

(76) Inventor: Udo Fischbeck, Furth (DE)

Correspondence Address: QUARLES & BRADY LLP, 411 E. WISCONSIN AVENUE, SUITE 2040, MILWAUKEE, WI, 53202-4497, US

(21) Appl. No.: 10/471,196

(22) PCT Filed: Feb. 26, 2002
(86) PCT No.: PCT/EP02/02019

(30) Foreign Application Priority Data
Mar. 14, 2001 (DE) 101 12 622.0

(51) Int. Cl. H04N 5/14

(52) U.S. Cl. 348/671; 348/797; 345/63

(57) ABSTRACT

The invention relates to a method and a device for improving the grey scale resolution of a pulse width modulated image display device. The time interval available for representing an image is divided into successive weighted partial time intervals comprising partial time intervals having low weighting and partial time intervals having high weighting. If the evaluation of the luminosity of the image to be represented causes a dark image to be detected, partial time intervals having high weighting are not required and the number of partial time intervals having low weightings is increased by using additional partial time intervals having low weightings. The weightings of the additional partial time intervals are different to the weightings of the first partial time intervals having low weightings. The grey scale resolution is thereby improved for dark images.

The invention concerns a method and device for improvement of the gray scale resolution of a pulse-width-modulated image display device.

This type of method and device are used, for example, in plasma displays, which will supplement or replace in the future the color image tubes now still being used in higher grade televisions. In conjunction with color image tubes, the user of high grade televisions has been accustomed, since the late 80's, to a picture free of flicker, based on 100 Hz technology.

A plasma display consisting of two glass plates with electrodes arranged matrix-like, between which an inert gas mixture is situated, is known from the journal Radio Fernsehen Elektronik RFE, Number 2, 1997, pages 18-20. The image information in the plasma displays is not depicted line by line, as in cathode ray tubes, but as a full image. Since the individual pixels in a plasma display cannot be turned on and off individually at arbitrary times, activation of the pixels must occur for the entire display in one activation pass.

Driving of the plasma display occurs in several phases: an addressing or initialization phase, a holding or activation phase and an erase phase.

In the addressing or initialization phase, all lines of the plasma display that are to be activated in the subsequent holding or activation phase are precharged. In the last step, in the erase phase, the precharged lines are discharged again and the image information is erased.

The time interval available for depiction of a television picture is broken down into time intervals of different duration or different weighting, during which a stipulated activation sequence is chosen as a function of the brightness value of the corresponding pixel. This corresponds to single or repeated illumination of the corresponding pixel during the time interval available for image depiction, in which a stipulated time is assigned to each illumination.

Such known plasma displays are marketed, for example, by Fujitsu and NEC.

A method and device for flicker reduction in pulse-width-modulated image display devices is known from DE A1 198 33 597, especially in a color plasma display. This type of color plasma display is used to depict television images. The color plasma display is driven by means of a pulse width modulator, in which, for control, the duration of a television image is broken down into a series of partial images or partial time intervals that are depicted in succession. For flicker reduction, especially a 50 Hz flicker reduction, the sequence of partial time intervals and/or activation sequences of the partial time intervals is stipulated, so that the flicker of the images being depicted is minimal.

A motion-detector-dependent change in sequence of the partial time intervals is also known from DE-A1 198 37 307. In the presence of movements, the sequence of the partial time intervals is chosen, so that movement artifacts are avoided. Otherwise, the choice of the sequence of partial time intervals occurs so that 50 Hz flicker disturbances are reduced.

In addition, in conjunction with plasma displays, it is already known to record the brightness of an image being depicted to derive a maximum admissible illumination time from the recorded brightness value for each of the partial time intervals of the image being depicted and, during a change in the recorded brightness value, to change the maximum admissible illumination time for each of the partial time intervals. This change occurs so that, when a dark image content or low brightness value is recorded, the maximum admissible illumination time in each partial time interval is increased by the same duration. On the other hand, if the brightness recording of the image being displayed shows that an overall brighter image content is present, the maximum admissible illumination time for each of the partial time intervals is then reduced by a time that is equal for all partial time intervals.

A drawback of this procedure is that the contrast of the image being depicted is reduced, since, with a recorded greater brightness of the image being depicted, the duration is reduced for depiction of bright image components and, with a recorded low brightness of an image being depicted, dark gray image components are depicted light gray, since these are pulled upward with a constant offset by the described effect, i.e., are illuminated longer.

Starting from this prior art, the underlying task of the invention is to show a way to improve gray scale resolution in a pulse-width-modulated image display device.

This task is solved by a method with the features mentioned in claim 1 or by a device with the features mentioned in claim 4.

Advantageous embodiments and modifications of the invention are apparent from the dependent claims.

By means of recording of the brightness mentioned in claims 2 and 5 by averaging the brightness values of all image points of the image being depicted, a situation is achieved, in which the additional cost to be incurred is low. In pulse-width-modulated image display devices, an image memory is generally present anyway, in which the data of a full image are stored. By means of a simple calculation process, the desired brightness information can be derived from these data.

By the recording of the brightness described in claims 3 and 6 by evaluation of the instantaneous current consumption of the image display device, indirect recording of the brightness of the image being depicted occurs, which better accommodates the circumstances of the display itself.

Additional advantageous properties of the invention are apparent from the explanation of a practical example by means of the figures.

In the figures:

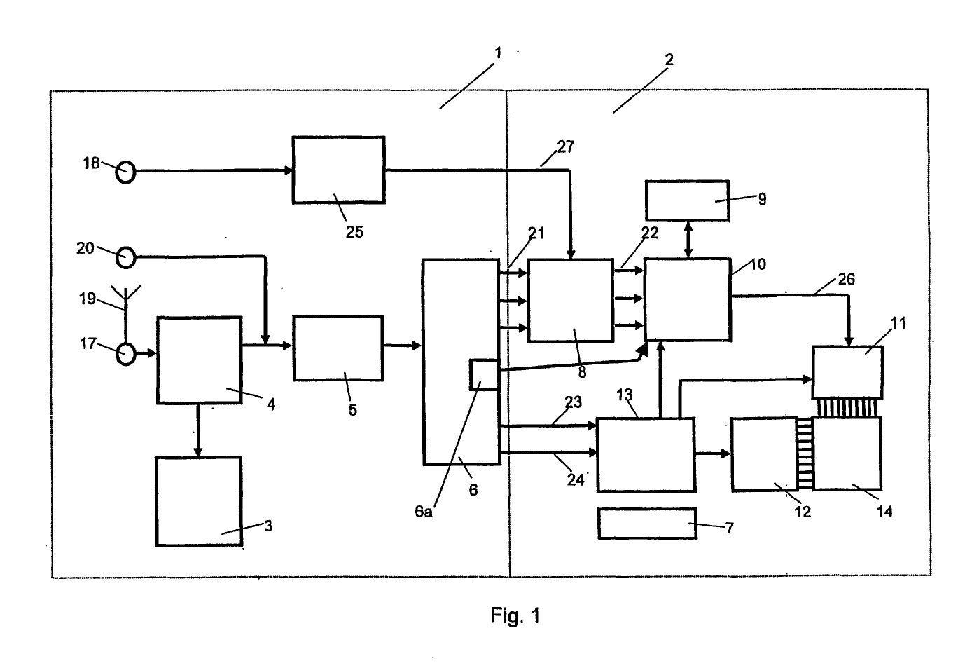

FIG. 1 shows a block diagram of a television receiver with a pulse-width-modulated plasma display;

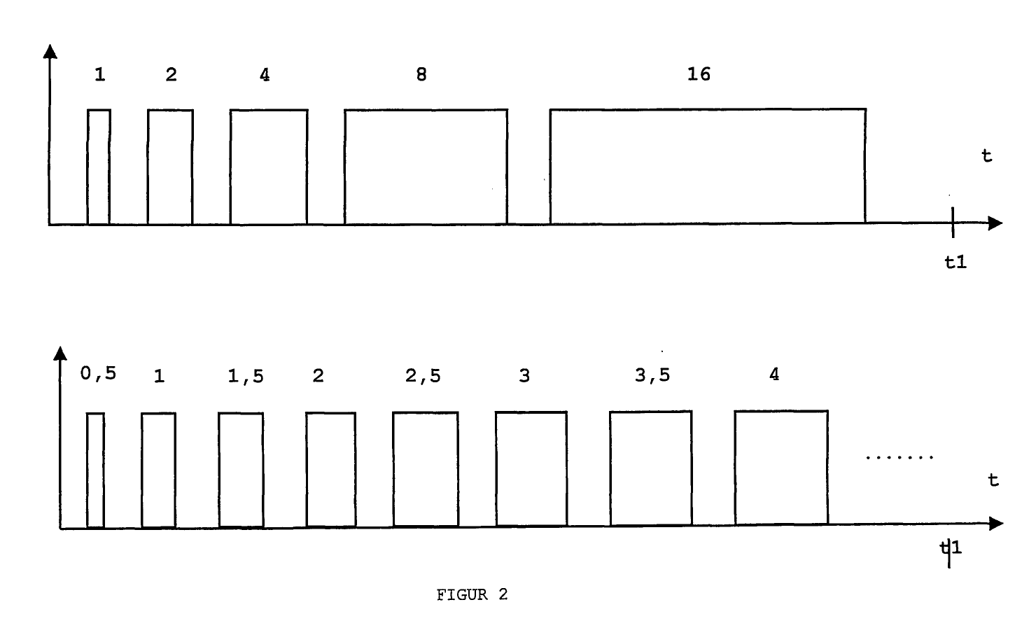

FIG. 2 shows a diagram to explain the invention and

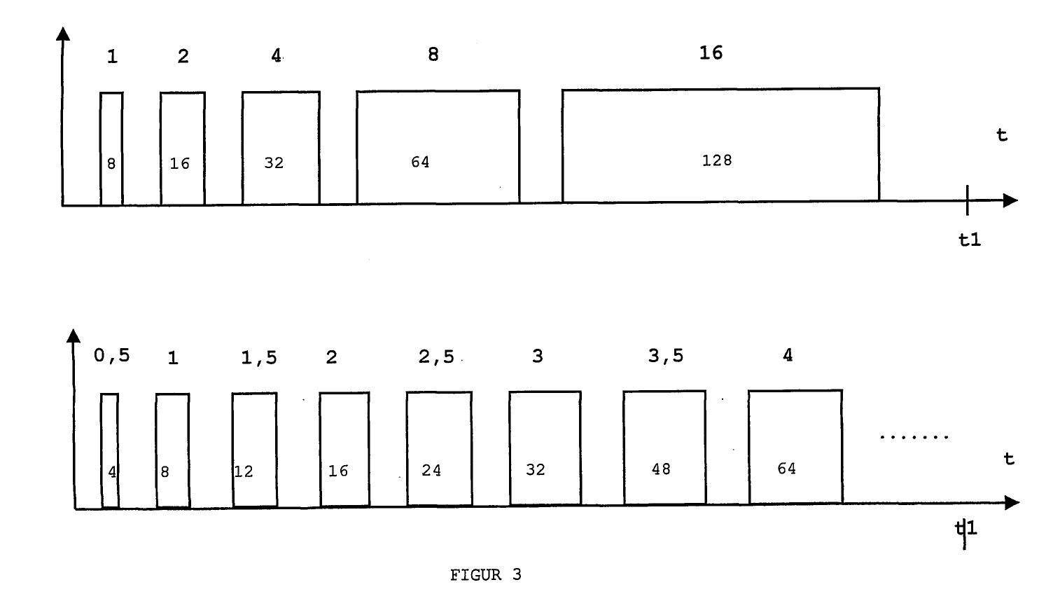

FIG. 3 shows another diagram to explain the invention.

FIG. 1 shows a block diagram of a television receiver with a pulse-width-modulated plasma display. The television receiver 1, 2 has a television signal processing part 1 and an image processing part 2.

The television signal processing part 1 has a first input 17, to which the signals of an antenna device 19 are fed. The signals of the input 17 are sent to a high-frequency and an intermediate-frequency processing unit 4 and an audio signal processing unit 3. At the output of the high-frequency and intermediate-frequency processing unit 4, an FBAS signal is present, which is fed to an analog/digital converter 5. Supply of an external FBAS signal is possible via a second signal input 20. The output signal of the analog/digital converter 5 is then fed to a so-called feature box 6. The feature box 6 executes certain functions, like demodulation of the FBAS signal, still image, zoom, format adjustment, image sharpness optimization, image-in-image, etc. The digital components Y, U, V of an image signal 21 so formed are sent to a digital matrix unit 8 of the image processing part 2. The feature box 6 also serves to convert the line jump signal to a line-jump-free signal and for necessary adjustment of the signal to the screen 14 by line interpolation. This occurs by means of synchronization signals 23, 24 for vertical and horizontal synchronization.

The digital matrix unit 8 also has a connection 27 to supply a VGA signal fed via an external signal input 18, which is converted to a digital signal by means of an analog/digital converter 25. An RGB signal 22 is present at the output of the digital matrix unit 8, with which a pulse width modulator 10 is driven. The pulse width modulator 10 generates the control signals 26 for an address driver 11. A memory 9 is coupled to the pulse width modulator 10 for this signal generation. The pulse width modulator 10 has a partial time interval weighting unit, which serves to weight the partial time intervals, i.e., to establish their sequence and duration. The address driver device 11 drives the individual columns of the plasma screen 14 line by line. The corresponding time control occurs by means of the time control device 13, which establishes the beginning of the partial time intervals and the times for the addressing and activation phase. For this purpose, the partial time interval line control device contained in the time control is used. The time control device 13 is connected to a horizontal driver 12. This horizontal driver 12 is active during the activation phases. The power supply occurs by means of a line voltage part 7.

Whereas the method of function and design of the television signal processing part 1 corresponds essentially to that of a conventional television receiver, the design of the image processing part 2 is fundamentally different. The main reason for this is that the plasma display device 14 has a digital connection between the input quantities and illumination density. Only two states therefore exist: on or off. In order to be able to achieve a large variety of different intermediate gray values, a digital time multiplexing method is used in the image processing part 2 depicted in FIG. 1 for image depiction. In it, the RGB signals 22 are broken down into several partial time intervals of different duration, i.e., into partial time intervals of different weighting.

This occurs by means of the pulse width modulator 10 and the additional units that drive the pulse width modulator, like the time control device 13 and a memory 9. Because of the inertia of the human eye, individual image changes no longer appear on the plasma display device 14, but instead a gray value that depends on the average activation time. If this time is weighted in the partial time intervals, numerous gray values can be depicted with few partial time intervals. During binary weighting (1, 2, 4, 8, . . . ), two to the power of the number of partial time intervals of gray values can be depicted. In order to be able to depict as many gray values as possible, it is therefore desirable to use as many partial time intervals as possible, which, however, is not possible, because of technological boundary conditions. The pulse width modulator 10 determines the sequence and activation of individual partial time intervals by an allocation that is dependent on its input signal level for each image point of the image being depicted. In the case of the binary weighting, this allocation appears, so that the longest time interval is assigned to the digitally highest weighted bit, the second longest time interval is assigned to the second highest weighted bit, etc.

According to the invention, the pulse width modulator 10, in its allocation of illumination times for the individual partial time intervals considers the information determined from the brightness detector 6a via the brightness content of the image being depicted. How this occurs is explained below with reference to FIG. 2, which shows the diagram to explain the invention.

In the upper part of FIG. 2, the time interval available for image depiction is divided into five consecutive binary-weighted partial time intervals. The first partial time interval has the value 1, the second partial time interval the value 2, the third partial time interval the value 4, the fourth partial time interval the value 8 and the fifth partial time interval the value 16. In the first, second and third partial time intervals, partial time intervals with low weightings are involved and, in the fourth and fifth partial time intervals, partial intervals with higher weightings are involved.

The partial time intervals in the figure are arranged within the total time interval available for image depiction, which extends from t=0 to t=t1, in succession in the sense of increasing weighting. However, as is known from the prior art mentioned in the introduction, the sequence of the weighted partial time intervals can also be chosen differently, for example, in the sense of a large surface flicker reduction.

In the upper part of FIG. 2, the time interval available for image depiction is also broken down into five consecutive binary-weighted partial time intervals. This serves merely for clarification.

Under practical conditions, a different number of binary-weighted partial time intervals is chosen, for example, 8 partial time intervals. With this choice, a total of 255 gray values can be depicted.

If it is detected, by means of brightness detector 6a, that a bright image is present, image depiction then occurs, using the weighting scheme just described, in which both first partial time intervals with low weightings are used, i.e., the partial time intervals with the weightings 1, 2 and 4, and second partial time intervals with higher weightings are used, i.e., the partial time intervals of the binary weightings 8 and 16.

If, on the other hand, it is detected, by means of the brightness detector 6a, that a dark image is present, image depiction then occurs, using the weighting scheme depicted in the lower part of FIG. 2. In this case, the use of the aforementioned second partial time intervals with higher weightings, i.e., partial time intervals with the weightings 8 and 16, is dispensed with. Instead, the number of partial time intervals with low weightings is increased by using additional partial time intervals with low weightings, in which the weightings of the additional time intervals differ from the weightings of the first partial time intervals with low weightings.

It thus follows from the lower part of FIG. 2 that, in addition to partial time intervals with weightings 1, 2 and 4, which are also present in the upper part of FIG. 2, additional partial time intervals with the weightings 0.5; 1; 1.5; 2; 2.5; 3; 3.5 and 4 are also present there.

By using these additional partial time intervals with low weightings, the gray scale resolution of the image depicted on display unit 14 is improved. This improvement is achieved in all images identified as dark. In these dark images, the use of partial time intervals of higher value can be dispensed with.

In the lower part of FIG. 2, the partial time intervals are arranged within the total time interval available for image depiction, which extends from t=0 to t=t1, in the sense of an increasing weighting consecutively. However, as was described in conjunction with the upper part of FIG. 2 and as known from the prior art mentioned in the introduction, the sequence of weighted partial time intervals can also be chosen differently, for example, in the sense of a flicker reduction.

The division of the time interval available for image depiction also occurs in the lower part of FIG. 2 in a total of eight time intervals of different weighting only for explanation of the invention. In practice, a different number of weighted partial time intervals can also be used. Advantageously, it is sufficient to evaluate the MSB (most significant bit). If the depiction of the MSB drops out in the time interval, the possibility is offered in the time interval of depicting smaller subfields, i.e., subfields with lower weighting, instead of subfields with larger weighting. It is also possible to completely dispense with the depiction of pixels, in which an MSB is placed, if the number is low during depiction of a half-image. However, this means that distortion of the depiction of the bright region occurs. At the same time, however, improved depiction for scenes in a dark region occurs, since more subfields can be used for its depiction and these can consequently be better resolved.

A partial time interval consists of several subfields to be activated with several discharges of the plasma cells to generate the image being depicted. This type of discharge is referred to as a sustain pulse. The number of sustain pulses is reduced according to the invention. This is shown as an example in FIG. 3.

As an alterative to the practical example described above, in which determination of information occurs via the brightness content of an image being depicted, using a brightness detector 6a arranged in feature box 6, the required brightness information can also be determined by means of a current consumption detector. This current consumption detector evaluates the instantaneous current consumption of the image display device and makes the required information available to the pulse width modulator 10.

In addition, in the practical example described above, a distinction was only made between the presence of bright and the presence of dark images. The principle of the invention can also be expanded to the extent that a distinction is made between the presence of bright, medium bright and dark images and, as a function of this, different weighting schemes can be chosen, whose characteristics are preferably entered in a memory, which is addressed as a function of the output signal with a brightness detector.

An advantageous modification of the invention consists of conducting an evaluation of the brightness of several consecutive images and carrying out time filtering of the determined brightness information. This achieves a situation, in which switching between the two weighting schemes depicted in FIG. 2 does not occur image by image.

1. Method for improvement of gray scale resolution in a pulse-width-modulated image display device, in which the time interval available for image depiction is divided into successive weighting partial time intervals, in which first partial time intervals are provided with lower weighting and second partial time intervals with higher weighting, and the brightness signals pertaining to the image point of the image being depicted are generated by conversion in activation sequences assigned to the partial time intervals, and in which the brightness of an image being depicted is recorded,
characterized by the fact
that, on recognition of dark images, the use of the second partial time intervals with higher weightings is dispensed with and, instead, the number of partial time intervals with lower weightings is increased by using additional partial time intervals with low weightings, in which the weightings of the additional partial time intervals differ from the weightings of the first partial time intervals with low weightings.

2. Method according to claim 1,
characterized by the fact
that recording of the brightness of the image being depicted occurs by means of the brightness values of all pixels of an image being depicted.

3. Method according to claim 1 or 2,
characterized by the fact
that recording of the brightness of the image being depicted occurs by evaluation of the instantaneous current consumption of the image display device.

4. Device for improvement of the gray scale resolution in a pulse-width-modulated image display device, with
drive devices (9-13) to divide the time intervals available for image depiction into consecutive weighted partial time intervals, in which first partial time intervals are provided with low weightings and second partial time intervals with higher weightings, and for generation of brightness signals corresponding to the pixels of the image being depicted by conversion into activation sequences assigned to the time intervals, and
with a brightness detector (6a) to record the brightness of the image being depicted, in which
the drive devices (9, 13) are provided so that during recognition of dark images, use of the second partial time intervals with higher weightings is dispensed with and, instead, the number of partial time intervals with low weightings is increased by using additional partial time intervals with low weightings,
in which the weightings of the additional partial time intervals differ from the weightings of the first partial time intervals with low weightings.

5. Device according to claim 4,
characterized by the fact
that it has an average value former (6) provided to average the brightness value of all pixels of an image being depicted.

6. Device according to claim 4 or 5,
characterized by the fact that it has a current consumption detector, provided to evaluate the instantaneous current consumption of the image display device.
